(19) United States
(12) Patent Application Publication
(10) Pub. No.: US 2008/0269337 A1
(43) Pub. Date: Oct. 30, 2008

(54) Method for the enhancing biocidal activity

(76) Inventors: Alexander W. Breen, Richmond Hill, GA (US); Michael J. Mayer, Jacksonville, FL (US)

Correspondence Address: Joanne Mary Fobare Rossi;Hercules Incorporated, Hercules Plaza, 1313 North Market Street, Wilmington, DE, 19894-0001, US

(21) Appl. No.: 11/796,863

(22) Filed: Apr. 30, 2007

(51) Int. Cl. A01N 37/02; A01P 1/00

(52) U.S. Cl. 514/574

(57) ABSTRACT

A treatment for enhancing the activity of isothiazolinone compounds to control the growth of microbes in an aqueous system is disclosed, which comprises adding to said isothiazolinone compounds an amount of an alkylsulfosuccinate surfactant sufficient to improve efficacy of the isothiazolinone compound. Each alkyl group of the alkylsulfosuccinate contains at least 10 carbons.

### FIELD OF THE INVENTION

The field of the invention is the treatment of industrial water to control microbiological growth.

### BACKGROUND OF INVENTION

Microbial growth in industrial process waters is a significant problem in many areas including the food, pharmaceutical, paint, oil processing and manufacturing, and pulp and paper. Uncontrolled growth of microoganisms can be responsible for degradation of products, odors, inhibition of heat transfer, or corrosion. In some cases microbiological contamination will cause human health problems by supporting the growth of pathogenic bacteria such as Legionella pneumophila or Bacillus cereus. In many cases industrial process waters provide an ideal environment for the proliferation of large and diverse bacterial populations. Abundant nutrients, elevated temperatures, and neutral pH are common conditions in process waters which are particularly prone to contamination. Control of microorganisms in industrial systems is accomplished with biocides.

Bacteria have a number of survival means to cope with biocides. Microbial growth in industrial systems occurs as both suspended (planktonic) and attached (sessile or biofilm) modes. In general, bacteria associated with biofilms are more difficult to irradicate than free living bacteria. Biofilm formation can be a survival response to toxicant exposure. Surfactants are routinely used in industrial water treatment for the removal of organic deposits from surfaces. Surfactants have long been part of biocide formulations, often to prevent separation or render hydrophobic compounds more miscible in water. They have also been shown to enhance the efficacy of some biocides towards biofilm populations (Glassman, 1948). The paper industry is particularly plagued by biofilm growth. Detachment of biofilm or bacterial slime during operation results in “sheet defects” (breaks, discoloration, holes).

Another survival strategy for some bacteria is spore formation. A diverse group of Gram positive bacteria are capable of sporulation as a means of surviving adverse conditions. These specialized bacteria are able to become dormant under stress and form spores which are resistant to many chemical as well as physical antibacterial measures. These organisms are ubiquitous in many environments and are of particular concern in food processing and food grade paper production. Spore forming bacteria can be particularly problematic for producers of many grades of paper. Unlike most bacteria, spore forming bacteria are capable of surviving the dryer section of paper machines. These organisms can then reside in the finished product until environmental conditions favor germination resulting in product spoilage. Surfactants enhancing the efficacy of FDA approved biocides against this class of bacteria would be of value to the industry.

Control of biofouling is critical in the pulp and paper industry. Biofilm on paper machine can lead to slime deposits on the product. Degradation or spoilage of additives in the papermaking process leads to decreased performance of these components. Microbial contamination can cause discoloration of dyes or separation of clay slurries. Starch, a commonly used additive in paper making and a readily usable carbon source for many bacteria, is particularly susceptible to microbial contamination and biodeterioration. Among the consequences of starch break down for papermakers are: loss of viscosity, odor, brightness decrease, and change in sheet formation. There are numerous potential sources of contamination. Although starch is cooked prior to application in paper making, as mentioned above, spore forming bacteria can survive the cooking process. Dilution water used for the starch slurry is another source of contamination as are airborne or aerosolized bacteria present in the mill environment. Starch or other additive preparations are commonly treated with biocides to mitigate microbial contamination. Given the inherent toxicity of biocides there are safety and environmental reasons to apply them judiciously.

Isothiazolinone (specifically, a mixture of 5-chloro-2-methyl-4-isothiazolin-3-one and 2-methyl-4-isothiazolin-3-one, sold as Kathon® 886F or Kathon® CF1400, (Rohm and Haas Company, Philadelphia, Pa.) is a heavily used biocide effective against a wide variety of microorganisms in a number of industrial applications. It is has a number of applications in the pulp and paper industry including; control of aerobic unicellular bacteria, filamentous bacteria and anaerobic bacteria in fresh water, thin stock, thick stock, and stock preservation applications. There are two notable drawbacks to its usage; i. it is a skin “sensitizer” meaning that repeated or prolonged exposure can result in an allergic type reaction, ii. resistance to this biocide has been documented with the end result being the need to apply continually higher concentrations to achieve efficacy.

Alkylsulfosuccinates are generally regarded as non-toxic compounds with a variety of applications. They are used when strong wetting, detergency, penetration, and solubilization characteristics are needed. In addition to their role as surfactants they can also be found as adjuvants in tablets, emulsifying agents in food and as ingredients in cosmetic and vitamin formulations. The combination of isothiazolinone with alkylsulfosuccinates has been noted in some previous patent literature but not as potentiators or enhancers of the efficacy of isothiazolinone. U.S. Pat. Nos. 4,975,109 and 5,256,182 teach that dioctylsulfosuccinate may be incorporated into formulations of isothiazolinone that incorporate oxidizers, specifically hydrogen peroxide, sodium perborate, potassium monosulfate, or sodium percarbonate.

A common application of isothiazolinone with alkylsulfosuccinates is the area of antimicrobial wipes. In these patents a surfactant is incorporated into the wipe to promote cleaning properties (see for example U.S. Pat. Nos. 6,432,904, 6,451,333, 6,488,943, 6,825,158, and 6,841,527). These patents do not note an enhancement of biocidal efficacy due to the incorporation of a sulfosuccinate into the wipe.

U.S. Pat. Nos. 5,607,597 and 5,736,056 teach that dioctyl and dinonylsulfosuccinates were shown to enhance the efficacy of isothiazolinone in aqueous industrial systems. However patent U.S. Pat. No. 5,736,056 also teaches that sulfosuccinates with longer alkylside chains, such as bistridecylsulfosuccinate, showed a loss of efficacy.

Industry is constantly searching for both effective biocides and environmentally sound practices. The enhancing the efficacy of isothiazolinone by a non-toxic potentiator would promote the use of lower concentrations of isothiazolinone which would have both health and environmental benefits.

### SUMMARY OF THE INVENTION

In this invention longer alky chain length sulfosuccinates, such as bistridecylsulfosuccinate and monotridecylsulfosuccinate, or higher, enhances the efficacy of isothiazolinone against bacterial populations. This invention also is effective to enhance efficacy of isothiazolinone with alkylsulfosuccinates against spore forming bacteria and is effective as a preservative for starch.

### BRIEF DESCRIPTION OF THE DRAWING

FIG. 1 depicts a graph of oxygen uptake profiles from whitewater bacterial populations.

### DETAILED DESCRIPTION OF THE INVENTION

The present invention relates to a method for enhancing the activity of a biocide compound to control the growth of microbes in an aqueous system. The treatment comprises adding to the aqueous system an effective amount of an anionic alkylsulfosuccinate surfactant wherein the length of the individual alkyl side chain is greater than decyl (C10). The preferred alkyl sulfosuccinate surfactants are tridecylsulfosuccinate and bistridecylsulfosuccinate. The method is used in the control of microorganisms in industrial aqueous systems, including but not limited to cooling water, metal working fluids, and pulp and paper manufacture. The method is also applied to enhance preservation of additive aqueous slurries, emulsions and suspensions including but not limited to starch, latex, pigments, and proteins. Aqueous systems such as metal working and oil and gas systems will also benefit from the present invention.

The method is effective against mixed bacterial culture comprised of bacteria indigenous to a paper mill process water (“whitewater”). The method may also be used to enhance the control of spore forming bacteria.

The method of the present invention allows for a decrease in the amount of biocidal compound added to the system, while maintaining the efficacy of the treatment. The present invention allows for a decrease in the amount of biocide used by employing a non-toxic surfactant to improve biocidal efficacy. Thus, a more environmentally acceptable outcome is achieved, in that less biocidal material may be used while still achieving the same level of efficacy.

The present invention pertains to the enhancement or potentiation of isothiazolinone by alkylsulfosuccinates to control the growth of microorganisms in industrial process streams and to supress microbial spoilage of chemical additives, most particularly in pulp and paper process systems.

One of the most commonly used additives in the manufacture of paper is starch which has several applications including fines retention and synthetic size emulsion stabilization. The most important application for starch is for the enhancement of dry strength. Starch granules can be slurried in water and cooked for application at the size press. Starch is an excellent growth medium for bacteria. Control of microbial growth in starch slurry preparations is critical to maintaining the desirable properties of starch for application in paper manufacture. Microorganisms are prodigious producers of amylases which can rapidly depolymerize and degrade starch. Isothiazolinone is a common choice of biocide for preservation of starch.

An biocide useful in the present invention is isothiazolinone (a mixture of 5-chloro-2-methyl-4-isothiazolin-3-one and 2-methyl-4-isothiazolin-3-one, sold as Kathon® RTM. 886F, available from Rohm and Haas Co., Philadelphia, Pa). The isothiazolinone compound is considered to be the preferred biocide active for the present invention.

The amount of isothiazolinone used in the present invention is generally at least 2.0 mg/l but can be at least 2.5 ppm, or a least about 5 ppm, or at least about 7.5 ppm.in the biocide solution.

The preferred range of isothiazolinone is from 2.0 ppm to about 15 ppm.

The amount of alkylsulfosuccinate surfactant used in the present invention is generally at least about 0.01 mg/l. The amount of alkyl sulfosuccinate surfactant can be at least about 0.05 mg/l, or at least about 0.07 mg/l, or at least about 7.5 ppm, but not greater than 33 mg/l.

The biocide and the alkylsulfosuccinate surfactant can be added together or separately to the industrial water system being treated.

The preferred alkylsulfosuccinate surfactant, bistridecylsulfosuccinate, demonstrated a significant enhancement of isothiazolinone activity.

This effect is seen as an enhancement of isothiazolinone activity, because the surfactant, alone, does not mediate significant toxicity upon the bacterial population.

It is expected that amounts of the treatment of the present invention as low as from about 1-5 ppm of biocide may be effective when enhanced with the alkylsulfosuccinate surfactant.

Following examples are intended to illustrate, but not to limit the invention.

### EXAMPLES

### Example 1

The results of adding sulfosuccinate surfactants to an undefined culture of whitewater bacteria treated with isothiazolinone are presented below. In this study individual test tubes were inoculated with a paper mill whitewater bacterial culture and dosed with 5 mg/l isothiazolinone. The isothiazolinone was supplemented with 20 mg/l of dioctylsulfosuccinate, bistridecylsulfosuccinate, and tridecylsulfosuccinate. The test medium used is described below. The control had no treatment.

A 2× synthetic stock medium was prepared with the following composition: CaCl₂ 222 mg/l, MgSO₄ 120 mg/l, NaHCO₃ 336 mg/l, K₂HPO₄ 280 mg/l, NH₄Cl 960 mg/l, FeCl₃.6(H₂O) 2.08 mg/l, Na₂EDTA 2.96 mg/l, Yeast Extract 2000 mg/l, HEPES 0.10M (23.83 g/L). The stock medium is brought up to one liter volume and the pH adjusted to pH 7.0 with NaOH. The 2× stock is then filter sterilized. The 2× stock is diluted to 0.1× concentration for antimicrobial testing.

Tests were conducted in a volume of 10 ml. The tubes were incubated at 37° C. and tested for bacterial viability at 3 hour and 20 hour time points by serial dilution and spread plating on to trypticase soy agar growth medium. Surviving bacterial numbers were determined by counting colonies appearing on plates after 48 hours at 37° C. The efficacy of the treatments was determined by comparison to untreated controls. Alkylsulfosuccinate addition results in a significant improvement in isothiazolinone efficacy for all compounds tested after a 20 hour exposure.

TABLE 1
Enhancement of isothiazolinone (iso) by alkylsulfosuccinates
(doss = dioctylsulfosuccinate, btdss = bistridecylsulfosuccinate,
tss = tridecylsulfosuccinate) against paper mill whitewater bacteria.
Unites are colony forming units per ml. (cfus/ml.

| | Treatment | | | | |
|---|---|---|---|---|---|
| Hours | Control | Iso only | Iso/doss | Iso/btdss | Iso/tss |
| 3 | 3.1 × 10⁷ | 5.0 × 10⁶ | 1.58 × 10⁵ | 1.62 × 10⁵ | 1.68 × 10⁵ |
| 20 | 6.8 × 10⁷ | 2.6 × 10⁵ | 1.5 × 10³ | 2.2 × 10³ | 2.6 × 10³ |

### Example 2

This example illustrates the enhancing effect of bistridecylsulfosuccinate on isothiazolinone by measuring inhibition of respiration. This example demonstrates that bistridecylsulfosuccinate can enhance the efficacy of isothiazolinone when both the isothiazolinone and the sulfosuccinate are present at low levels.

The data in this study was generated using the System OxiTop Control (WTW Measurement Systems, Inc. Ft. Myers Fla.). This apparatus is a closed system in which oxygen is consumed by respiring bacteria and converted in carbon dioxide. Carbon dioxide is absorbed in a sodium hydroxide trap which results in a pressure drop which is measured by a sensor. The sensor then converts the pressure drop into mg of oxygen consumed.

Isothiazolinone alone was dosed at a concentration of 0.25 ppm. An isothiazolinone/bistridecylsulfosuccinate formulation was dosed at 0.10 ppm isothiazolinone/0.08 ppm bistridecylsulfosuccinate and at 0.25 ppm isothiazolinone/0.2 ppm bistridecylsulfosuccinate.

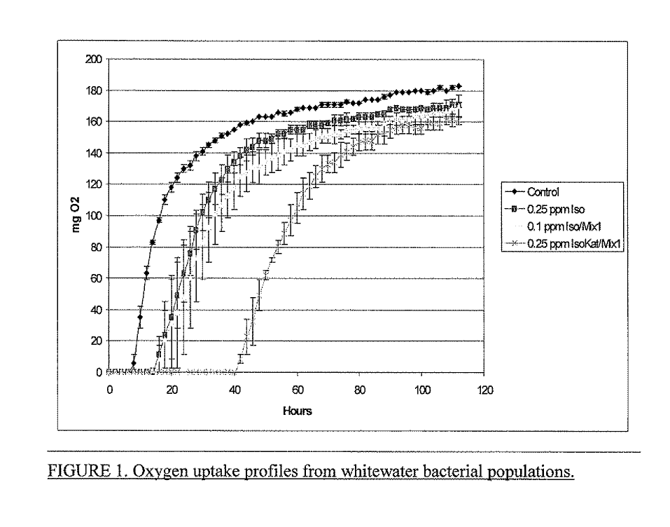

The study was run using an undefined whitewater bacterial population inoculated into 300 mls of 0.1× synthetic medium (composition as described above augmented with 500 mg/l glucose). Duplicate test vessels were run for each treatment as well as untreated controls. Prior to starting the experiment the vessels were brought to 37° C. to avoid any artifacts due to temperature fluctuations. In this study a blend of isothiazolinone and bistridecylsulfosuccinate, designated Mix 1 (3.5% isothiazolinone and 2.9% bistridecylsulfosuccinate), was used to dose the vessels. The date in FIG. 1 shows that isothiazolinone, when augmented by bistridecylsulfosuccinate, can achieve the same degree of respiratory inhibition as twice the concentration of isothiazolinone alone. FIG. 1 also shows that respiratory data from isothiazolinone at a concentration of 0.25 mg/l is statistically equivalent to the data from isothiazolinone at a concentration of 0.10 mg/l with 0.08 mg/l bistridecylsulfosuccinate.

### Example 3

This example illustrates the enhancing effect of bistridecylsulfosuccinate on isothiazolinone for preservation of a starch slurry.

The data in table 2 demonstrates the enhancing effect of bistridecylsulfosuccinate on isothiazolinone efficacy in a cooked starch solution inoculated with a bacterial population indigenous to a paper mill.

A 5% cooked starch mixture was prepared by adding starch granules to the synthetic medium described above in Example 2, and boiled. Upon boiling the starch slurry should be translucent. Two isothiazolinone formulations from Rohm and Haas Co. were examined; Kathon 886F, a formulation with 11.2% active isothiazolinone, and Kathon CF1400, a formulation with 14% isothiazolinone. Both formulations showed similar enhancement by bistridecylsulfosuccinate. The control had no treatment. Isothiazolinonecone was tested alone and then in combination with the bistridecylsulfosuccinate. The isothiazolinone concentration was 40 mg/l. The bistridecylsulfosuccinate (Btdss) concentration was 33 mg/l. Data were reported as colonies per ml slurry.

TABLE 2
Effect of isothiazolinone and bistridecylsulfosuccinate on
bacterial populations in cooked starch.

| Treatment | 2 Hour | 4 Hour | 6 Hour |
|---|---|---|---|
| Control | 1.60 × 10⁷ | 1.61 × 10⁸ | 1.00 × 10⁹ |
| Kathon 886F | 4.2 × 10⁶ | 1.19 × 10⁷ | 8.20 × 10⁶ |
| Kathon 886F | 1.40 × 10⁶ | 4.00 × 10⁵ | 3.6 × 10⁴ |
| and Btdss | | | |
| Kathon CF1400 | 1.5 × 10⁶ | 7.10 × 10⁴ | 4.6 × 10⁴ |
| and Btdss | | | |

### Example 4

Starch preservation was examined over a longer time frame and at lower isothiazolinone concentrations. A 5% cooked starch slurry was inoculated with indigenous paper mill bacteria and samples were tested for antimicrobial efficacy by serial dilution and plating. The study was carried out in 125 ml shake flasks using 50 mls volume of starch slurry. The flasks were shaken and incubated at 45° C. Table 3 shows enhancement of isothiazolinone performance at concentrations as low as 2-3 ppm isothiazolinone. Additionally, the combination of sulfosuccinate and isothiazolinone was able to suppress microbial growth for an extended period of time.

Isothiazolinone (Kathon 886F) was tested at 1, 2, and 3 mg/l concentration. The control had no treatment. Bistridecylsulfosuccinate (Btdss) was added to a concentration of 48 mg/l. Cultures were shaken in an incubator at 48° C. for the indicated periods.

TABLE 3
Effect of isothiazolinone and bistridecylsulfosuccinate on
bacterial populations in cooked starch.

| Treatment | 1.5 Hour | 22 Hour | 26 Hour |
|---|---|---|---|
| Control | 4.5 × 10³ | 8.3 × 10⁷ | 2.6 × 10⁸ |
| 1 mg/l iso | 3.7 × 10³ | 4.0 × 10⁷ | 4.0 × 10⁷ |
| 2 mg/l iso | 6.0 × 10² | 4.0 × 10⁷ | 2.2 × 10⁷ |
| 3 mg/l iso | 1.2 × 10³ | 4.0 × 10⁷ | 4.0 × 10⁷ |
| 1 mg/l iso/48 mg/l | 1.3 × 10³ | 4.0 × 10⁷ | 4.0 × 10⁷ |
| Btdss | | | |
| 2 mg/l iso/48 mg/l | 1.3 × 10³ | 6.8 × 10⁶ | 1.2 × 10⁷ |
| Btdss | | | |
| 3 mg/l iso/48 mg/l | 1.6 × 10³ | 1.0 × 10³ | 1.0 × 10³ |
| Btdss | | | |

### Example 5

By definition a potentiator compound will not, by itself, kill or inhibit the bacterial population. The non-toxicity of bistridecylsulfosuccinate to B. subtilus is illustrated in Table 4. One ml of bacteria from an overnight culture was used to innocculate shake flasks containing 50 mls of fresh synthetic medium. The synthetic medium (as described previously) was augmented with increasing amounts of bistridecylsulfosuccinate. Serial dilution and plating was carried out to compare the efficacy of each treatment. The culture of B. subtilus was grown in the presence of 0, 5, 10, and 20 mg/l bistridecylsulfosuccinate (Btdss). Plating was carried out at 2.5 hours and 5 hours of incubation. Table 4 shows that bistridecylsulfosuccinate HOW alone is non-toxic to B. subtilus at concentrations at least as high as 20 mg/l. The control had no treatment. In fact, the bistridecylsulfosuccinate treated cultures showed increased growth relative to the untreated control. However, when combined with isothiazolinone, the surfactant promotes more effective biocidal action (Table 5).

TABLE 4
B. subtilus (ATCC23059) growing in synthetic medium
in the presence and absence of bistridecylsulfosuccinate.

| Treatment | 2.4 Hour | 5 Hour |
|---|---|---|
| Control | 1.33 × 10⁷ | 3.01 × 10⁶ |
| 5 mg/l Btdss | 3.40 × 10⁶ | 4.00 × 10⁶ |
| 10 mg/l Btdss | 2.8 × 10⁶ | 3.90 × 10⁷ |
| 20 mg/l Btdss | 3.00 × 10⁶ | 3.6 × 10⁷ |

TABLE 5
Effect of isothiazolinone and isothiazolinone plus
bistridecylsulfosuccinate on B. subtilus
(ATCC23059) in synthetic medium.

| Treatment | 3 Hours Exposure (cfu/ml) |
|---|---|
| Control | 2.7 × 10⁷ |
| 1 mg/l Isothiazolinone | 2.7 × 10⁵ |
| 1 mg. Isothiazolinone + 20 mg/l | 6.4 × 10⁴ |
| Btdss | |

### Example 6

The spore forming bacterium B. cereus is of particular concern because of its pathogenic properties. Most incidents of food poisoning attributed to the genus Bacillus are caused by B. cereus. B. cereus is a common concern in production of dairy products. There is particular concern about this organism in powered milk based products for infants. This is a concern not only to producers of these goods but also to the manufacturers of packaging and containers for such products. Experiments using B. cereus ATCC14579 were carried out which demonstrate the improved efficacy of isothiazolinone when combined with bistridecylsulfosuccinate. A culture of B. cereus ATCC14579 was treated with isothiazolinone alone and isothiazolinone with bistridecylsulfosuccinate One ml of bacteria from an overnight culture was used to innocculate shake flasks containing 50 mls of fresh synthetic medium. The synthetic medium (as described previously) was dosed with isothiazolinone at one or two mg/l concentration; or isothiazolinone in conjunction with 20 mg/l bistridecylsulfosuccinate. Cultures were maintained shaking at 37° C. then carried through serial dilution and plated at 3 and 5 hour time points. As shown in table 6 bistridecylsulfosuceinate greatly enhanced the efficacy of isothiazolinone against B. cereus.

TABLE 6
The effect of isothiazolinone (iso) and isothiazolinone
with bistridecylsulfosuccinate (Btdss) on B. cereus.

| Treatment | 3 Hour | 5 Hour |
|---|---|---|
| Control | 1.93 × 10⁷ | 4.6 × 10⁶ |
| 1 mg/l iso | 1.66 × 10⁶ | 5.00 × 10⁶ |
| 2 mg/l iso | 6.6 × 10⁵ | 8.10 × 10⁴ |
| 1 mg/l iso 20 mg/l Btdss | 3.7 × 10⁴ | 1.7 × 10⁴ |
| 2 mg/l iso 20 mg/l Btdss | 7.00 × 10² | 9.90 × 10¹* |

*estimate - no growth at detection limit.

While certain embodiments of the present invention have been described herein, it is intended that there be covered as well any change or modification therein which may be made without departing from the spirit and scope of the invention.

What is claimed is:

1. A method for treating industrial water containing isothiazolinone to inhibit growth of microbes in said industrial water which comprises adding to said water an amount of alkylsulfocussinate sufficient to inhibit growth of microbes, said alkylsulfosuccinate present in amount between 0.01 and 33 mg/l., and said alkylsulfosuccinate having 10 carbons or more in each alkyl group.

2. The method of claim 1 wherein the alkylsulfosuccinate comprises bistridecylsulfosuccinate.

3. The method of claim 1 wherein the alkylsulfosuccinate is tridecylsulfosuccinate.

4. The method of claim 1 wherein the alkylsulfosuccinate comprises monodecylsulfosuccinate.

5. The method of claim 1 wherein the aqueous system comprises a cooling water system.

6. The method of claim 1 wherein the aqueous system comprises a pulp and paper making system.

7. The method of claim 1 wherein the aqueous system comprises a metal working system.

8. The method of claim 1 where microbes are spore forming bacteria.

9. The method of claim 8 wherein the spore forming bacteria are selected from B. subtilus and B. cereus.

10. The method as recited in claim 1 wherein said microbes comprise bacteria.
